(19) United States
(12) Patent Application Publication
(10) Pub. No.: US 2009/0192993 A1
(43) Pub. Date: Jul. 30, 2009

(54) METHOD AND SYSTEM FOR SETTING DOMAIN NAME AND NETWORK DEVICE THEREOF

(75) Inventors: Hung-De Liu, Taipei (TW); Shih-Hua Yu, Taipei (TW); Yi-Lun Chen, Taipei (TW); Chien-Chih Yeh, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTEK COMPUTER INC., Taipei (TW)

(21) Appl. No.: 12/258,460

(22) Filed: Oct. 27, 2008

(30) Foreign Application Priority Data
Jan. 24, 2008 (TW) 97102642

(51) Int. Cl. G06F 21/00; G06F 17/30

(52) U.S. Cl. 707/3; 726/3; 707/E17.014

(57) ABSTRACT

A method and a system for setting a domain name and a network device thereof are provided. In the invention, the network device includes built-in identification information, and the identification information is stored in a back-end database. When the network device receives a domain name, it transmits setting information to a server device. Then, the server device queries the identification information in the back-end database according to the setting information to authenticate the network device. After the network device passes the authentication, the server device maps the domain name to an Internet protocol address. Therefore, a step of registering an account and a password is omitted to simplify a procedure of setting the domain name.

### CROSS-REFERENCE TO RELATED APPLICATION

This application claims the priority benefit of Taiwan application serial no. 97102642, filed on Jan. 24, 2008. The entirety of the above-mentioned patent application is hereby incorporated by reference herein and made a part of specification.

### BACKGROUND OF THE INVENTION

1. Field of the Invention

The invention relates to a program for setting a domain name and, more particularly to, a method and a system for setting a domain name via built-in identification information and a network device thereof.

2. Description of the Related Art

Along with the great development of the Internet, the network communication service is greatly enhanced. In the world of Internet, the IP address of each host is unique to assure that data can be transmitted to the only destination. However, under some conditions, a computer system needs a static IP address to allow other users to communicate with it. For example, when establishing a connection based on the file transfer protocol (FTP), if the computer system does not have a static IP address, other users cannot be successfully connected to the computer system.

More and more companies are founded to provide the dynamic domain name system (DNS) service. The user applies for a domain name from the dynamic DNS service provider first. Then, the user sets the IP address of the computer system on the web page of the dynamic DNS service provider or via client software. In this way, others can connect to the computer system using the domain name without knowing the IP address of the computer system.

However, it is difficult for an ordinary user to apply for and to set the IP address of the computer system using the dynamic DNS service via the Internet. Although some suppliers apply for a plurality of accounts of the dynamic DNS service in advance and attach the accounts to the packages of the network devices, the users still cannot avoid the inconvenience of inputting and keeping the accounts and the passwords.

### BRIEF SUMMARY OF THE INVENTION

The invention provides a method for setting a domain name. A user only needs to input the domain name without an account and a password, and then he can rapidly register the domain name in a server device.

The invention provides a system and a network device for setting up a domain name. Identification information is assigned to the network device when it is manufactured. Furthermore, a dynamic DNS service system is established with an accompanying client application module installed at the network device. This arrangement not only simplifies the installation and setting processes, but also reduces the inconvenience of keeping the account and the password.

The invention provides a method for setting a domain name for a network device having built-in identification information and a back-end database storing the identification information. First, the network device receives a domain name and transmits setting information to a server device. The setting information includes the domain name, the identification information and an Internet protocol (IP) address provided by the network device. Next, the server device queries the identification information in the back-end database according to the setting information to authenticate the network device. Finally, after the network device passes the authentication, the server device maps the domain name to the IP address.

In one embodiment of the invention, in the step of receiving the domain name at the network device and enabling the network device to transmit the setting information to the server device includes the step of retrieving the identification information from the storage unit of the network device first. Next, the network device generates a first authentication code according to the identification information. Then, the network device transmits a device identification code in the first authentication code, the domain name, the IP address and the identification information to the server device.

In one embodiment of the invention, the step of querying the identification information in the back-up database according to the setting information to authenticate the network device by the server device includes the step of retrieving the identification information from the back-end database according to the device identification code by the server device. Next, the server device generates a second authentication code according to the identification information to determine whether the first authentication code is the same with the second authentication code. If they are the same, the network device passes the authentication.

In one embodiment of the invention, the domain name and the IP address that the domain name is mapped to are recorded in a mapping table in the server device. After the network device passes the authentication, if the setting information includes a name setting request, the server device checks whether the domain name exists in the mapping table. When the domain name does not exist in the mapping table, the domain name and the IP address are recorded into the mapping table. If the setting information includes an address updating request, the server device checks whether the domain name exists in the mapping table. When the domain name exists in the mapping table, the mapping table is updated to map the domain name to another IP address carried by the setting information.

The invention provides a system for setting a domain name, and the system includes a network device, a back-end database and a server device. The network device has built-in identification information. After the network device receives the domain name, it transmits setting information including the domain name, the identification information and the IP address provided by the network device. The back-end database is used to store the identification information. The server device is coupled to the network device via the Internet, and it is used to receive the setting information. The server device queries the identification information in the back-end database according to the setting information to authenticate the network device, and when the network passes the authentication, the domain name is mapped to the IP address.

In one embodiment of the invention, the network device includes a storage unit and a client application module. The storage unit is used to store the identification information. The client application module is used to retrieve the identification information from the storage unit, generates a first authentication code according to the identification information and transmits a device identification code in the first authentication code, the domain name, the IP address and the identification information to the server device. The client application module can provide a user interface for a user to input the domain name.

In one embodiment of the invention, the server device includes an authentication module, a mapping module and a mapping table. The authentication module queries the identification information in the back-end database according to the setting information to generate a second authentication code, and it determines that the network device passes the authentication when the second authentication code is the same with the first authentication code in the setting information. The mapping module is used to map the domain name to the IP address and record the domain name and the IP address. The mapping module further checks whether the domain name exists in the server device. The mapping table is used to record the domain name and the IP address that the domain name is mapped to.

The invention provides a network device including a storage unit and a client application module. The storage unit is used to store the identification information. The client application module is used to retrieve the identification information from the storage unit and transmit the identification information, the domain name and the IP address to the server device. After the server device determines that the network device passes the authentication based on the identification information, it maps the domain name to the IP address.

In one embodiment of the invention, the client application module further provides a user interface for a user to input the domain name. The client application module further generates a first authentication code according to the identification information and transmits a device identification code in the first authentication code, the domain name, the IP address and the identification information to the server device. The server device queries the identification information in the back-up database based on the device identification code to authenticate the network device.

As for the invention, when the network device is manufactured, identification information is disposed therein, and the identification information also is stored to the back-up database. Therefore, the identification information built-in the network device can be used to authenticate the network device without the account and the password. A user does not need to register a group of account and password for identification in the server device, which is rapid and convenient in use.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing a system for setting a domain name according to the first embodiment of the invention.

FIG. 2 is a flow chart showing a method for setting a domain name according to the first embodiment of the invention.

FIG. 3 is a block diagram showing a system for setting a domain name according to the second embodiment of the invention.

FIG. 4A and FIG. 4B are flow charts showing a method for setting a domain name according to the second embodiment of the invention.

### DETAILED DESCRIPTION OF THE EMBODIMENTS

If a user wants to apply the dynamic domain name system (DNS) service, he should apply for a group of account and password in a web page created by a service supplier, and then, the user can log in the server device with the account and the password. The complicated operation process for an ordinary user is very difficult. Therefore, the invention provides a system and a method for setting a domain name and a network device thereof to simplify the operating process. To make the content of the invention to be better understood, embodiments of the invention are illustrated hereinbelow.

### First Embodiment

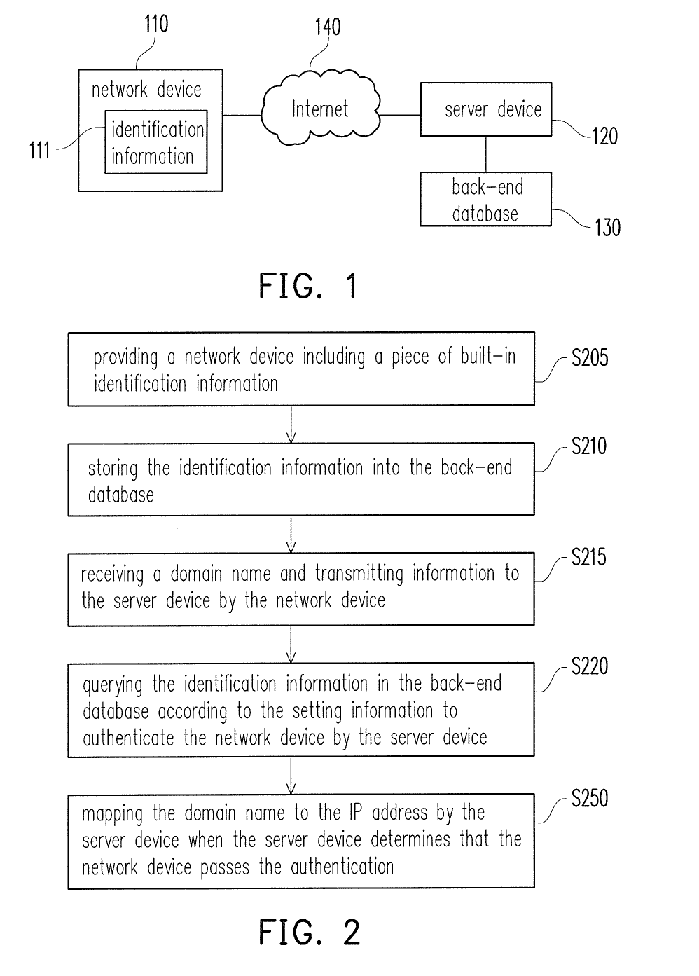

FIG. 1 is a block diagram showing a system for setting a domain name according to the first embodiment of the invention. As shown in FIG. 1, the system includes a network device 110 having built-in identification information 111, a server device 120 and a back-end database 130. The network device 110 is coupled to the server device 120 via the Internet 140. In the embodiment, the network 110 is, for example, an Internet protocol (IP) address sharing device, and the server device 120 is, for example, a dynamic domain name system (DNS) server.

The network device 110 is used to receive a domain name and transmit setting information to the server device 120. The setting information is used to allow the domain name to be mapped to the IP address provided by the network device 110. The setting information includes the domain name, the identification information and the IP address provided by the network device 110.

The server device 120 is coupled to the network device 110 via the Internet 140 and is used to receive the setting information. The server device 120 queries the identification information in the back-end database 130 according to the setting information to authenticate the network device 110 and map the domain name to the IP address provided by the network device 110 when the network device 110 passes the authentication.

The back-end database 130 is used to store the identification information of the network device 110 for the server device 120 to perform an action of authenticating the network device. For example, when the network device 110 is manufactured, a group of identification information such as a media access control (MAC) address and a personal identification number (PIN) is assigned to and stored into the network device 110 by a production line test program. The production line test program also stores the identification information of the network device 110 into the back-end database 130 for the server device 120 to query.

In the embodiment, the back-end database 130 is independent of the server device 120. However, in other embodiments, the back-end database 130 also can be disposed in the server device 120 according to an actual condition, and it is not limited in the invention.

A method for setting a domain name is illustrated with the system for setting the domain name. FIG. 2 is a flow chart showing the method for setting the domain name according to the first embodiment of the invention. As shown in FIG. 1 and FIG. 2, in step S205, a network device 110 having built-in identification information 111 is provided first. When the network device 110 is manufactured in the factory, the identification information is generated via the random number of the production line test program, and the identification information is stored into the network device 110. In step S210, the production line test program stores the identification information into the back-end database 130.

In step S215, the network device 110 receives a domain name and transmits the setting information to the server device 120. In other words, the user can input a domain name via the network device 110, and then the network device 110 packages the domain name, the identification information 111 and the IP address as a packet and transmits the packet to the server device 120.

In step S220, the server device 120 queries the identification information 111 built-in the network device 110 in the back-end database 130 according to the setting information in the packet to authenticate the network device 110. That is, the action of querying the identification information in the back-end database 130 is used to authenticate whether the network device 110 has the authority of using the server device 120 to set the domain name. Finally, in step S250, when the network device 110 passes the authentication, the server device 120 maps the domain name to the IP address of the network device 110.

To sum up, in the embodiment, the user only needs to transmit the domain name such as “userasuscomm.com” to the server device 120 via the network device 110 to register the domain name, and then he can create a website with “user.asuscomm.com”. Then, other persons can connect to the network device 110 via “user.asuscomm.com” and access the host of the website, and it is convenient in use.

### Second Embodiment

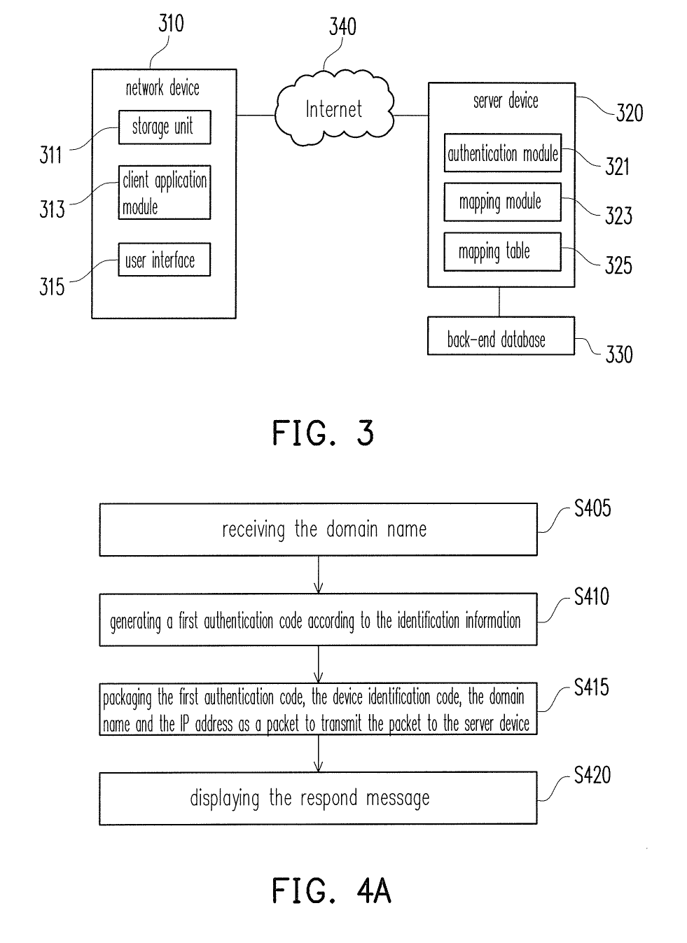

FIG. 3 is a block diagram showing a system for setting a domain name according to the second embodiment of the invention. As shown in FIG. 3, the system includes a network device 310, a server device 320 and a back-end database 330. The network device 310 is coupled to the server device 320 via the Internet 340 to communicate.

The network device 310 includes a storage unit 311, a client application module 313 and a user interface 315. The storage unit 311 is used to store built-in identification information. The user interface 315 is provided for a user to input the domain name. When the network device 310 wants to access the server device 320, it retrieves the identification information from the storage unit 311 via the client application module 313 to transmit the identification information, the domain name and the IP address to the server device 320.

The server device 320 includes an authentication module 321, a mapping module 323 and a mapping table 325. The authentication module 321 queries the identification information in the back-end database 330 according to the setting information transmitted by the network device 310 to authenticate the network device 310. The mapping module 323 is used to map the domain name to the IP address and record the domain name and the IP address into the mapping table 325.

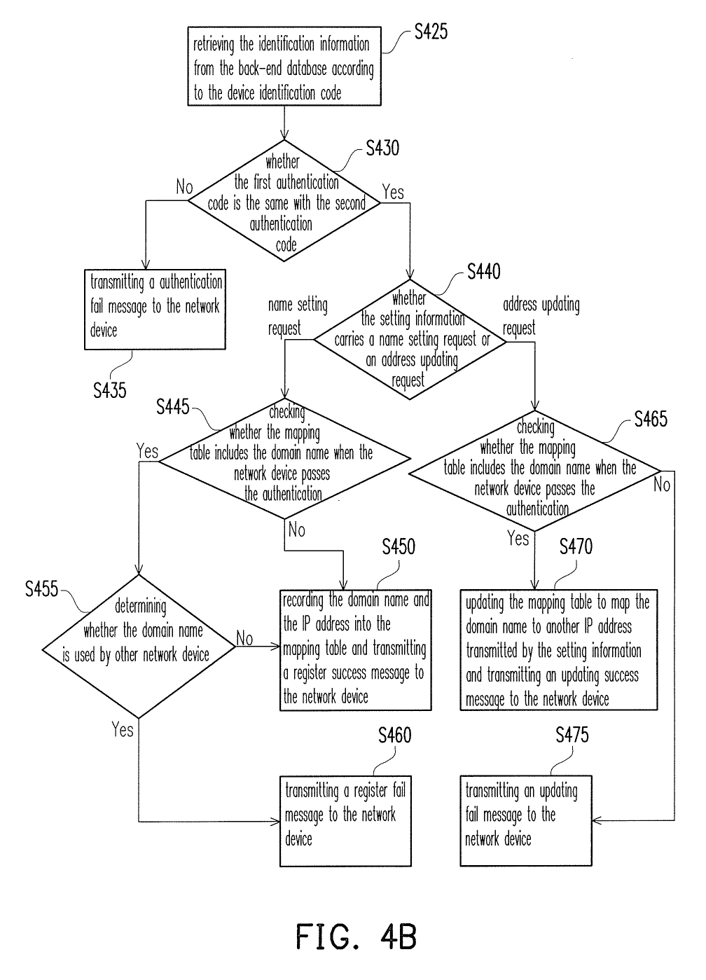

A method for setting a domain name is illustrated with the system for setting the domain name. The FIG. 4A and FIG. 4B are flow charts showing the method for setting the domain name according to the second embodiment of the invention. FIG. 4A shows the steps that are executed in the network device 310, and FIG. 4B shows the steps that are executed in the server device 320.

As shown in FIG. 3 and FIG. 4A, in step S405, the user interface 315 provided by the client application module 313 is used to receive the domain name input by the user. In step S410, the client application module 313 generates a first authentication code according to the identification information. In other words, the client application module 313 retrieves the identification information from the storage unit 311 to generate the first authentication code. In step S415, the client application module 313 packages the setting information such as the device identification code (such as the MAC address) in the first authentication code, the domain name, the IP address and the identification information as a packet and transmits the packet to the server device 320.

As shown in FIG. 3 and FIG. 4B, in step S425, in the server device 320, the authentication module 321 retrieves the identification information from the back-end database 323 according to the packet transmitted by the network device 310 to generate a second authentication code. For example, the authentication module 321 retrieves the identification information (such as the personal identification number) corresponding to the device identification code from the back-end database 323 according to the device identification code in the packet to generate the second authentication code. In the sever device 320, the method of generating the second authentication code is the same with the method of generating the first authentication code used by the network device 310.

Afterwards, the authentication module 321 determines whether the first authentication code is the same with the second authentication code. If no, it determines that the network device 310 does not pass the authentication, and step S43 5 is executed. That is, the server device 320 transmits an authentication fail message to the network device 310. If yes, it determines that the network device 310 passes the authentication, and step S440 is executed.

In step S440, the mapping module 323 determines whether the setting information in the packet carries a name setting request or an address updating request. If the setting information carries the name setting request, step S445 is executed. If the setting information carries the address updating request, step S465 is executed.

When the setting information carries the name setting request, as shown in step S445, the mapping module 323 checks whether the mapping table 325 includes the domain name transmitted by the network device 310. If the mapping table 325 does not include the domain name, that is, the domain name is not registered by other users, in step S450, the mapping module 323 records the domain name and the IP address of the network device 310 into the mapping table 325 to make a mapping between the domain name and the IP address. A register success message is transmitted to the network device 310.

If the mapping table 325 includes the domain name, as in step S455, the mapping module 323 determines whether the domain name is used by other network device. That is, whether the network device 310 wants to re-register its domain name is determined. If the domain name carried by the packet is used by other network device, step S460 is executed, and a register fail message is transmitted to the network device 310 by the server device 320.

If the domain name carried by the packet is the domain name that is originally set for the network device 310, step S450 is executed. The mapping module 323 records the domain name carried by the packet and the IP address of the network device 310 into the mapping table 325 to make a mapping between the domain name and the IP address. That is, the mapping module 323 make the domain name in the packet replace the domain name in the mapping table 325 to reset the domain name.

Returning to step S440, when the setting information carries the address updating request, in step S465, the mapping module 323 checks whether the mapping table 325 includes the domain name transmitted by the network device 310. If the mapping table 325 includes the domain name, it represents that the network device 310 is successfully registered before. Therefore, step S470 is executed. That is, the mapping module 323 updates the mapping table 325 to allow the domain name originally set for the network device 310 to be mapped to another IP address carried by the setting information, and an updating success message is transmitted to the network device 310. If the mapping table 325 does not include the domain name, that is the network device 310 is not registered with the domain name, step S475 is executed. That is, the server device 320 transmits an updating fail message to the network device 310.

As shown in FIG. 4A, after steps S425 to S475 are executed, in step S420, the network device 310 shows the messages such as the authentication fail message (in step S435), the register success message (in step S450), the register fail message (in step S460), the updating success message (in step S470) and the updating fail message (in step S475) via the user interface 315.

To sum up, via the above embodiments, the user does not need to apply for an account and a password by himself, and therefore, he does not need to remember the account and the password and worry about losing or forgetting the account and the password. The user only needs to input the needed domain name without the complicated operating steps, which is rapid, time-consuming and convenient. Furthermore, the packet transmitted by the network device can only carry the device identification code, and the server device can retrieve the identification information from the back-end database via the device identification code to authenticate the network device. Therefore, it is effective to prevent the network device from being faked.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A method for setting a domain name, which is suitable for a network device having built-in identification information and a back-end database storing the identification information, the method comprising the steps of:
receiving a domain name at the network device and enabling the network device to transmit a setting information to a server device, wherein the setting information includes the domain name, the identification information and an Internet protocol (IP) address provided by the network device;
querying the identification information in the back-up database according to the setting information to authenticate the network device at the server device; and
mapping the domain name to the IP address by the server device after the network device passes the authentication.

2. The method for setting the domain name according to claim 1, wherein the step of enabling the network device to transmit the setting information to the server device further comprises the steps of:
retrieving the identification information from a storage unit of the network device;
generating a first authentication code according to the identification information by the network device; and
transmitting a device identification code in the first authentication code, the domain name, the IP address and the identification information to the server device.

3. The method for setting the domain name according to claim 2, wherein the step of querying the identification information in the back-up database according to the setting information to authenticate the network device by the server device comprises the steps of:
retrieving the identification information from the back-end database according to the device identification code by the server device;
generating a second authentication code according to the identification information by the server device; and
determining whether the first authentication code is the same with the second authentication code, wherein when the first authentication code and the second authentication code are the same, the network device is determined to pass the authentication.

4. The method for setting the domain name according to claim 1, wherein the domain name and the IP address that the domain name is mapped to are recorded in a mapping table in the server device.

5. The method for setting the domain name according to claim 4, wherein after the network device passes the authentication, the method further comprises the steps of:
checking whether the domain name exists in the mapping table by the server device if the setting information includes a name setting request; and
recording the domain name and the IP address into the mapping table when the domain name does not exist in the mapping table.

6. The method for setting the domain name according to claim 4, wherein after the network device passes the authentication, the method further comprises the steps of:
checking whether the domain name exists in the mapping table by the server device if the setting information includes an address updating request; and
updating the mapping table to map the domain name to a IP address carried by the setting information when the domain name exists in the mapping table.

7. A system for setting a domain name, comprising:
a network device having built-in identification information and for receiving a domain name to transmit a setting information including the domain name, the identification information and a IP address provided by the network device;
a back-up database for storing the identification information; and
a server device coupled to the network device via the Internet and for receiving the setting information and querying the identification information in the back-up database according to the setting information to authenticate the network device, wherein when the network device passes the authentication, the domain name is mapped to the IP address.

8. The system for setting the domain name according to claim 7, wherein the network device comprises:
a storage unit for storing the identification information; and
a client application module for retrieving the identification information from the storage unit, generating a first authentication code according to the identification information and transmitting a device identification code in the first authentication code, the domain name, the IP address and the identification information to the server device.

9. The system for setting the domain name according to claim 8, wherein the client application module further provides a user interface for a user to input the domain name.

10. The system for setting the domain name according to claim 7, wherein the server device further comprises:
an authentication module for querying the identification information in the back-up database according to the setting information to authenticate the network device; and
a mapping module for mapping the domain name to the IP address and recording the domain name and the IP address.

11. The system for setting the domain name according to claim 10, wherein the authentication module further generates a second authentication code according to the identification information, and the authentication module determines that the network device passes the authentication when the second authentication code is the same with a first authentication code in the setting information.

12. The system for setting the domain name according to claim 10, wherein the mapping module further checks whether the domain name exists in the server device.

13. The system for setting the domain name according to claim 7, wherein the server device further comprises:
a mapping table for recording the domain name and the IP address that the domain name is mapped to.

14. A network device connected to a server device, the network device comprising:
a storage unit for storing identification information; and
a client application module for retrieving the identification information from the storage unit and transmitting the identification information, the domain name and a IP address to the server device, wherein after the server device determines that the network device passes the authentication according to the identification information, the server device maps the domain name to the IP address.

15. The network device according to claim 14, wherein the client application module further provides a user interface for a user to input the domain name.

16. The network device according to claim 14, wherein the client application module further generates a first authentication code according to the identification information and transmits a device identification code in the first authentication code, the domain name, the IP address and the identification information to the server device to allow the server device to query the identification information in a back-up database according to the device identification code to authenticate the network device.
